(19) United States
(12) Patent Application Publication
(10) Pub. No.: US 2025/0357850 A1
(43) Pub. Date: Nov. 20, 2025

(54) INTER-TURN PROTECTION METHOD AND SYSTEM FOR CONVERTER TRANSFORMER

(71) Applicants: CHINA ELECTRIC POWER RESEARCH INSTITUTE, Beijing (CN); STATE GRID CORPORATION OF CHINA, Beijing (CN)

(72) Inventors: Dingxiang DU, Beijing (CN); Guosheng YANG, Beijing (CN); Hong CAO, Beijing (CN); Pengfei LYU, Beijing (CN); Ying LIANG, Beijing (CN); Chenguang GAO, Beijing (CN)

(21) Appl. No.: 18/874,115

(22) PCT Filed: Aug. 24, 2023
(86) PCT No.: PCT/CN2023/114702

§ 371 Date: Dec. 12, 2024

(30) Foreign Application Priority Data
Jun. 24, 2022 (CN) 202210724335.2

(51) Int. Cl. H02M 1/32; H02M 1/00; H02M 5/12

(52) U.S. Cl. CPC H02M 1/325; H02M 1/0009; H02M 5/12

(57) ABSTRACT

The present application provides an inter-turn protection method and system for a converter transformer. In the method and system, three-phase currents before and after initiating inter-turn protection are collected at a valve side and at a grid side of a converter transformer, and a three-phase differential current, a three-phase differential current variation, and a fundamental phasor of the sum of positive and negative sequences of the three-phase differential current variation of the converter transformer are calculated according to the three-phase current; then, criterion results for a differential protection criterion, a second harmonic blocking criterion, a waveform identification open criterion, and a sequence differential current open criterion are determined according to the calculated parameter values; and last, whether inter-turn protection actuates is determined according to the criterion results. When a developmental inter-turn short circuit fault occurs in a converter transformer and differential protection can not rapidly identify and remove the fault due to the time for second harmonic blocking being relatively long, the present method and system quickly perform inter-turn protection action output, and protection sensitivity and action speed during an inter-turn fault are greatly improved.

### CROSS-REFERENCE TO RELATED APPLICATIONS

The present application is filed on the basis of Chinese Patent Application No. 202210724335.2, filed on Jun. 24, 2022 and entitled “Inter-turn Protection Method and System for Converter Transformer”, and claims priority to this Chinese patent application, which is incorporated herein by reference in its entirety.

### TECHNICAL FIELD

The present disclosure relates to the technical field of relay protection, and in particular to an inter-turn protection method and system for a converter transformer.

### BACKGROUND

An ultra-high voltage direct current power transmission system is an important component of an ultra-high voltage grid, and a converter transformer serves as a dividing point between an alternating current part and a direct current part, and is a core device of an interface at both ends of rectification and inversion in an alternating/direct current power transmission system. Safe operation of the converter transformer is the key and important guarantee for an ultra-high voltage direct current power transmission project to achieve benefits, and is of great importance.

According to statistics of device fault data of converter stations over years, about 60% to 70% of internal faults of converter transformers are inter-turn short-circuit faults caused by damaged insulation between turns of a winding. In case that the capacity of the alternating current system is large, the winding in which insulation between turns is damaged is instantaneously subjected to great energy, resulting in a serious fault of the device, or even burning of the converter transformer. The converter transformer is typically provided with electric power protection and non-electric power protection, and with respect to damaged insulation between turns of a winding in a steady state, main protection such as large differential ratio differential protection, Y/Y transformer ratio differential protection, and Y/D transformer ratio differential protection of the converter transformer in the electric power protection can quickly identify a short-circuit fault between the turns of the winding in the steady state, and gas protection and the like in the non-electric power protection can also identify a short-circuit fault between the turns of the winding in the steady state, thereby effectively protecting the device.

However, as the voltage level of the alternating current power grid connected to the ultra-high voltage converter station becomes higher and higher, an internal short-circuit resulting from damaged insulation between turns of a winding of a converter transformer may rapidly develop into a multi-turn short-circuit, and a transient short-circuit current increases dramatically, resulting in a rapidly developing fault condition. The differential protection of the converter transformer is provided with a second harmonic blocking function, so that in case that the content of second harmonics is greater than a certain value, the differential protection outlet is blocked to prevent a magnetizing inrush current from causing malfunctioning of the differential protection. It is difficult to distinguish the feature of a rapid increase in current in the developing short-circuit fault between turns of the converter transformer from the feature of second harmonics generated by a magnetizing inrush current, so that the differential protection of the converter transformer cannot quickly identify and isolate the fault due to a long second harmonic blocking time, and safe and stable operation of the device or even the system may be jeopardized.

In order to greatly improve the sensitivity and speed of the protection operation at the moment of an inter-turn fault, it is necessary to provide the converter transformer with highly sensitive and fast inter-turn protection.

### SUMMARY

In order to solve the technical problem in the prior art that damaged insulation between turns of a winding of a converter transformer results in a rapidly developing fault condition, but the existing protection method cannot quickly identify the fault condition, the present disclosure provides an inter-turn protection method and system for a converter transformer.

An embodiment of the present disclosure provides an inter-turn protection method for a converter transformer, which includes that:
three-phase currents i_{Φpri}(tₐⱼ) of a grid side of a converter transformer at a moment tₐⱼ and three-phase currents i_{Φva}(tₐⱼ) of a valve side of the converter transformer at the moment tₐⱼ, and three-phase currents i_{Φpri}(t_{gj}) of the grid side of the converter transformer at a moment t_{gj} and three-phase currents i_{Φva}(t_{gj}) of the valve side at the moment t_{gj} are acquired; herein Φ represents three phases A, B, and C of the converter transformer, t_{gj} is a j-th sampling moment of a time window before activation of inter-turn protection, tₐⱼ is a j-th sampling moment of an a-th time window after the activation of inter-turn protection, N is the total number of sampling moments in one time window, a≥1, 1≤j≤N, a, j, and N are all natural numbers, and positive directions of the three-phase currents i_{Φpri}(tₐⱼ), i_{Φva}(tₐⱼ), i_{Φpri}(t_{gj}), and i_{Φva}(t_{gj}) are all directed to the inside of the transformer;
three-phase differential currents i_{diffΦ}(tₐⱼ) of the converter transformer at the moment tₐⱼ are respectively calculated according to the three-phase currents i_{Φpri}(tₐⱼ) of the grid side and the three-phase currents i_{Φva}(tₐⱼ) of the valve side; and three-phase differential currents i_{diffΦ}(t_{gj}) of the converter transformer at the moment t_{gj} are respectively calculated according to the three-phase currents i_{Φpri}(t_{gj}) of the grid side and the three-phase currents i_{Φva}(t_{gj}) of the valve side;
fundamental effective values I_{diffΦ}(tₐⱼ) and second harmonic effective values i_{diff2Φ}(tₐⱼ) of the three-phase differential currents i_{diffΦ}(tₐⱼ) of the converter transformer at the moment tₐⱼ are respectively calculated according to the three-phase differential currents i_{diffΦ}(tₐⱼ);
fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ are respectively calculated according to the three-phase differential currents i_{diffΦ}(tₐⱼ) and the three-phase differential currents i_{diffΦ}(t_{gj});
first criterion results of the three phases are respectively determined according to the fundamental effective values i_{diffΦ}(tₐⱼ) of the three-phase differential currents i_{diffΦ}(tₐⱼ) and a differential protection criterion which is preset; second criterion results of the three phases are respectively determined according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset; third criterion results of the three phases are respectively determined according to the three-phase differential currents i_{diffΦ}(tₐⱼ) and a waveform identification open criterion which is preset; and fourth criterion results of the three phases are respectively determined according to the fundamental phasors ΔI_{diffΦ±}(tₐⱼ) and a sequence differential current open criterion which is preset; and
output results of respective inter-turn protection actions are determined according to the first criterion results, the second criterion results, the third criterion results, and the fourth criterion results of the three phases.

In some embodiments, for the operations of the respectively calculating three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side, and respectively calculating three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side, calculation formulas of the three-phase differential currents i_{diffΦ}(tₐⱼ) and i_{diffΦ}(t_{gj}) are respectively formula (1) and formula (2):

$${i}_{diff Φ} ( {t}_{aj} ) = {i}_{Φ pri} ( {t}_{aj} ) + {i}_{Φ va} ( {t}_{aj} ) \div ratio , and \qquad ( 1 )$$

$${i}_{diff Φ} ( {t}_{gj} ) = {i}_{Φ pri} ( {t}_{gj} ) + {i}_{Φ va} ( {t}_{gj} ) \div ratio , \qquad ( 2 )$$

herein Φ is the three phases A, B, and C, and the ratio is a converter transformer ratio.

In some embodiments, the operation of respectively calculating fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}) includes that:
the three-phase differential current variations Δi_{diffΦ}(tₐⱼ) of the converter transformer at the moment tₐⱼ are respectively calculated according to the three-phase differential currents i_{diffΦ}(tₐⱼ) and i_{diffΦ}(t_{gj}), and a calculation formula of the three-phase differential current variations Δi_{diffΦ}(tₐⱼ) is formula (3):

$$Δ {i}_{diff Φ} ( {t}_{aj} ) = {i}_{diff Φ} ( {t}_{aj} ) - {i}_{diff Φ} ( {t}_{gj} ) ; \qquad ( 3 )$$

a zero-sequence component Δi_{diff0}(tₐⱼ) of the three-phase differential current variations Δi_{diffΦ}(tₐⱼ) of the converter transformer at the moment tₐⱼ is calculated according to the three-phase differential current variations Δi_{diffΦ}(tₐⱼ), a calculation formula of the zero-sequence component Δi_{diff0}(tₐⱼ) is formula (4):

$$Δ {i}_{diff 0} ( {t}_{aj} ) = [ Δ {i}_{diffA} ( {t}_{aj} ) + Δ {i}_{diffB} ( {t}_{aj} ) + Δ {i}_{diffC} ( {t}_{aj} ) ] \div 3 ; \qquad ( 4 )$$

the positive and negative sequence component sums ΔI_{diffΦ±}(tₐⱼ) of the three-phase differential current variations Δi_{diffΦ}(tₐⱼ) of the converter transformer at the moment tₐⱼ are respectively calculated according to the three-phase differential current variations Δi_{diffΦ}(tₐⱼ) and the zero-sequence component Δi_{diff0}(tₐⱼ), and a calculation formula of the positive and negative sequence component sums Δi_{diffΦ±}(tₐⱼ) is formula (5):

$$Δ {i}_{diff Φ \pm } ( {t}_{aj} ) = Δ {i}_{diff Φ} ( {t}_{aj} ) - Δ {i}_{diff 0} ( {t}_{aj} ) ; \qquad ( 5 )$$

the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ) of the converter transformer at the moment tₐⱼ are respectively calculated according to the positive and negative sequence component sums ΔI_{diffΦ±}(tₐⱼ) of the three-phase differential current variations Δi_{diffΦ}(tₐⱼ).

In some embodiments, for the operations of respectively determining first criterion results of the three phases according to the fundamental effective values I_{diffΦ}(tₐⱼ) of the three-phase differential currents i_{diffΦ}(tₐⱼ) and a differential protection criterion which is preset, respectively determining second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset, respectively determining third criterion results of the three phases according to the three-phase differential currents i_{diffΦ}(tₐⱼ) and a waveform identification open criterion which is preset, and respectively determining fourth criterion results of the three phases according to the fundamental phasors ΔI_{diffΦ±}(tₐⱼ) and a sequence differential current open criterion which is preset, in which:
a formula of the differential protection criterion is formula (6):

$$\{ \begin{matrix}{I}_{diff ϕ} ( {t}_{aj} ) > {I}_{cdqd} & {I}_{res ϕ} ( {t}_{aj} ) \leq {I}_{res 0} \\ {I}_{diff ϕ} ( {t}_{aj} ) > {I}_{cdqd} + {k}_{0} ( {I}_{res ϕ} ( {t}_{aj} ) - {I}_{res 0} ) & {I}_{res ϕ} ( {t}_{aj} ) > {I}_{res 0}\end{matrix} , \qquad ( 6 )$$

herein I_{resΦ}(tₐⱼ)=|i_{Φpri}(tₐⱼ)−i_{Φva}(tₐⱼ)±ratio|/2, Iᵣₑₛ₀ and k₀ are both constants, I_{cdqd} is a preset first coefficient, the first criterion results are that: the differential protection criterion is satisfied in case that the formula of the differential protection criterion is true, or the differential protection criterion is not satisfied in case that the formula of the differential protection criterion is false;
a formula of the second harmonic blocking criterion is formula (7):

$${I}_{diff 2 Φ} ( {t}_{aj} ) > {k}_{1} {I}_{diff Φ} ( {t}_{aj} ) , \qquad ( 7 )$$

herein k₁ is a preset second coefficient, the second criterion results are that: the second harmonic blocking criterion is satisfied in case that the formula of the second harmonic blocking criterion is true, or the second harmonic blocking criterion is not satisfied in case that the formula of the second harmonic blocking criterion is false;
a formula of the waveform identification open criterion is formula (8):

$$\{ \begin{matrix}{I}_{diff ϕ} ( {t}_{2} ) > {I}_{cdqd} \\ \frac{{\sum }_{{t}_{0}}^{{t}_{1}} \vert {i}_{diff Φ} ( {t}_{aj} ) \vert}{{\sum }_{{t}_{1}}^{{t}_{2}} \vert {i}_{diff Φ} ( {t}_{aj} ) \vert} < {P}_{set}\end{matrix} , \qquad ( 8 )$$

herein t₀ is a protection activation moment, t₁ is a first stage moment, t₂ is a second stage moment, t₁ and t₂ are empirical values determined based on an inrush current interruption angle feature, t₁<t₂<20 ms, Pₛₑₜ is an opening coefficient and is an empirical value set to ensure sensitivity to an inter-turn fault; the third criterion results are that: the waveform identification open criterion is satisfied in case that the three-phase differential currents i_{diffΦ}(tₐⱼ) make the formula of the waveform identification open criterion true, or the waveform identification open criterion is not satisfied in case that the three-phase differential currents i_{diffΦ}(tₐⱼ) make the formula of the waveform identification open criterion false;
formulas of the sequence differential current open criterion are formula (9) and formula (10):

$$\vert Δ {I}_{diffmax \pm } ( {t}_{aj} ) + 2 Δ {I}_{diffx \pm } ( {t}_{aj} ) \vert < {k}_{2} \vert Δ {I}_{diffmax \pm } ( {t}_{aj} ) \vert , and \qquad ( 9 )$$

$$\vert Δ {I}_{diffmax \pm } ( {t}_{aj} ) + 2 Δ {I}_{diffy \pm } ( {t}_{aj} ) \vert < {k}_{2} \vert Δ {I}_{diffmax \pm } ( {t}_{aj} ) \vert , \qquad ( 10 )$$

herein ΔI_{diffmax±}(tₐⱼ)=max{ΔI_{diffA±}(tₐⱼ), ΔI_{diffB±}(tₐⱼ)ΔI_{diffC±}(tₐⱼ)}, ΔI_{diffx±}(tₐⱼ) and ΔI_{diffy±}(tₐⱼ) are the fundamental phasors of the positive and negative sequence component sums of the differential current variations of the remaining two phases other than ΔI_{diffmax±}(tₐⱼ) among the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ), k₂<1; the fourth criterion results are that: a phase corresponding to ΔI_{diffmax±}(tₐⱼ) among the three phases satisfies the sequence differential current open criterion and the remaining two phases do not satisfy the sequence differential current open criterion in case that the two formulas of the sequence differential current open criterion are both true; or none of the three phases satisfies the sequence differential current open criterion in case that either one of the two formulas of the sequence differential current open criterion is false.

In some embodiments, the operation of determining output results of respective inter-turn protection actions according to the first criterion results, the second criterion results, the third criterion results, and the fourth criterion results of the three phases includes that:
in case that the first criterion result of a phase among the three phases is that the differential protection criterion is satisfied and the second criterion result of the phase is that the second harmonic blocking criterion is not satisfied, an inter-turn protection action outlet of the phase is determined; or in case that the first criterion result of a phase among the three phases is that the differential protection criterion is satisfied, the second criterion result of the phase is that the second harmonic blocking criterion is satisfied, the third criterion result of the phase is that the waveform identification open criterion is satisfied, and the fourth criterion result of the phase is that the sequence differential current open criterion is satisfied, an inter-turn protection action outlet of the phase is determined.

An embodiment of the present disclosure provides an inter-turn protection system for a converter transformer, the system includes a data acquisition unit, a first calculation unit, a second calculation unit, a third calculation unit, a criterion result unit and a protection action unit.

The data acquisition unit is configured to acquire: three-phase currents i_{Φpri}(tₐⱼ) of a grid side of a converter transformer at a moment tₐⱼ and three-phase currents i_{Φva}(tₐⱼ) of a valve side of the converter transformer at the moment tₐⱼ, and three-phase currents i_{Φpri}(t_{gj}) of the grid side of the converter transformer at a moment t_{gj} and three-phase currents i_{Φva}(t_{gj}) of the valve side at the moment t_{gj}. Herein, Φ represents three phases A, B, and C of the converter transformer, t_{gj} is a j-th sampling moment of a time window before activation of inter-turn protection, tₐⱼ is a j-th sampling moment of an a-th time window after activation of inter-turn protection, N is the total number of sampling moments in one time window, a ≥1, 1≤j≤N, a, j, and N are all natural numbers, and positive directions of the three-phase currents i_{Φpri}(tₐⱼ), i_{Φva}(tₐⱼ), i_{Φpri}(t_{gj}), and i_{Φva}(t_{gj}) are all directed to the inside of the transformer.

The first calculation unit is configured to: respectively calculate three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side; and respectively calculate three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side.

The second calculation unit is configured to respectively calculate fundamental effective values I_{diffΦ}(tₐⱼ) and second harmonic effective values I_{diff2Φ}(tₐⱼ) of the three-phase differential currents i_{diffΦ}(tₐⱼ) of the converter transformer at the moment tₐⱼ according to the three-phase differential currents i_{diffΦ}(tₐⱼ).

The third calculation unit is configured to: respectively calculate fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}).

The criterion result unit is configured to: respectively determine first criterion results of the three phases according to the fundamental effective values I_{diffΦ}(tₐⱼ) of the three-phase differential currents i_{diffΦ}(tₐⱼ) and a differential protection criterion which is preset, respectively determine second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset, respectively determine third criterion results of the three phases according to the three-phase differential currents i_{diffΦ}(tₐⱼ) and a waveform identification open criterion which is preset, and respectively determine fourth criterion results of the three phases according to the fundamental phasors ΔI_{diffΦ±}(tₐⱼ) and a sequence differential current open criterion which is preset.

The protection action unit is configured to determine output results of respective inter-turn protection actions according to the first criterion results, the second criterion results, the third criterion results, and the fourth criterion results of the three phases.

In some embodiments, the first calculation unit respectively calculates three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side, and respectively calculates three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side; herein calculation formulas of the three-phase differential currents i_{diffΦ}(tₐⱼ) and i_{diffΦ}(t_{gj}) are respectively formula (1) and formula (2):

$${i}_{diff Φ} ( {t}_{aj} ) = {i}_{Φ pri} ( {t}_{aj} ) + {i}_{Φ va} ( {t}_{aj} ) \div ratio , and \qquad ( 1 )$$

$${i}_{diff Φ} ( {t}_{gj} ) = {i}_{Φ pri} ( {t}_{gj} ) + {i}_{Φ va} ( {t}_{gj} ) \div ratio , \qquad ( 2 )$$

herein, Φ is the three phases A, B, and C, and the ratio is a converter transformer ratio.

In some embodiments, the third calculation unit respectively calculating fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}) includes that:
the three-phase differential current variations Δi_{diffΦ}(tₐⱼ) of the converter transformer at the moment tₐⱼ are respectively calculated according to the three-phase differential currents i_{diffΦ}(tₐⱼ) and i_{diffΦ}(t_{gj}), a calculation formula of the three-phase differential current variations Δi_{diffΦ}(tₐⱼ) is formula (3):

$$Δ {i}_{diff Φ} ( {t}_{aj} ) = {i}_{diff Φ} ( {t}_{aj} ) - {i}_{diff Φ} ( {t}_{gj} ) ; \qquad ( 3 )$$

a zero-sequence component Δi_{diff0}(tₐⱼ) of the three-phase differential current variations Δi_{diffΦ}(tₐⱼ) of the converter transformer at the moment tₐⱼ is calculated according to the three-phase differential current variations Δi_{diffΦ}(tₐⱼ), a calculation formula of the zero-sequence component Δi_{diff0}(tₐⱼ) is formula (4):

$$Δ {i}_{diff 0} ( {t}_{aj} ) = [ Δ {i}_{diffA} ( {t}_{aj} ) + Δ {i}_{diffB} ( {t}_{aj} ) + Δ {i}_{diffC} ( {t}_{aj} ) ] \div 3 ; \qquad ( 4 )$$

the positive and negative sequence component sums Δi_{diffΦ±}(tₐⱼ) of the three-phase differential current variations Δi_{diffΦ}(tₐⱼ) of the converter transformer at the moment tₐⱼ are respectively calculated according to the three-phase differential current variations Δi_{diffΦ}(tₐⱼ) and the zero-sequence component Δi_{diff0}(tₐⱼ), a calculation formula of the positive and negative sequence component sums ΔI_{diffΦ±}(tₐⱼ) is formula (5):

$$Δ {i}_{diff Φ \pm } ( {t}_{aj} ) = Δ {i}_{diff Φ} ( {t}_{aj} ) - Δ {i}_{diff 0} ( {t}_{aj} ) ; \qquad ( 5 )$$

the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ) of the converter transformer at the moment tₐⱼ are respectively calculated according to the positive and negative sequence component sums Δi_{diffΦ±}(tₐⱼ) of the three-phase differential current variations Δi_{diffΦ}(tₐⱼ).

In some embodiments, the criterion result unit includes a first criterion unit, a second criterion unit, a third criterion unit and a fourth criterion unit.

The first criterion unit is configured to respectively determine the first criterion results of the three phases according to the fundamental effective values I_{diffΦ}(tₐⱼ) of the three-phase differential currents i_{diffΦ}(tₐⱼ) and the differential protection criterion which is preset, herein a formula of the differential protection criterion is formula (6):

$$\{ \begin{matrix}{I}_{diff ϕ} ( {t}_{aj} ) > {I}_{cdqd} & {I}_{res ϕ} ( {t}_{aj} ) \leq {I}_{res 0} \\ {I}_{diff ϕ} ( {t}_{aj} ) > {I}_{cdqd} + {k}_{0} ( {I}_{res ϕ} ( {t}_{aj} ) - {I}_{res 0} ) & {I}_{res ϕ} ( {t}_{aj} ) > {I}_{res 0}\end{matrix} , \qquad ( 6 )$$

herein, I_{resΦ}(tₐⱼ)=|i_{Φpri}(tₐⱼ)−i_{Φva}(tₐⱼ)÷ratio|/2, Iᵣₑₛ₀ and k₀ are both constants, I_{cdqd} is a preset first coefficient, the first criterion results are that: the differential protection criterion is satisfied in case that the formula of the differential protection criterion is true, or the differential protection criterion is not satisfied in case that the formula of the differential protection criterion is false.

The second criterion unit is configured to respectively determine the second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and the second harmonic blocking criterion which is preset, herein a formula of the second harmonic blocking criterion is formula (7):

$${I}_{diff 2 Φ} ( {t}_{aj} ) > {k}_{1} {I}_{diff Φ} ( {t}_{aj} ) , \qquad ( 7 )$$

wherein k₁ is a preset second coefficient, the second criterion results are that: the second harmonic blocking criterion is satisfied in case that the formula of the second harmonic blocking criterion is true, or the second harmonic blocking criterion is not satisfied in case that the formula of the second harmonic blocking criterion is false.

The third criterion unit is configured to respectively determine the third criterion results of the three phases according to the three-phase differential currents i_{diffΦ}(tₐⱼ) and the waveform identification open criterion which is preset, herein a formula of the waveform identification open criterion is formula (8):

$$\{ \begin{matrix}{I}_{diff ϕ} ( {t}_{2} ) > {I}_{cdqd} \\ \frac{{\sum }_{{t}_{0}}^{{t}_{1}} \vert {i}_{diff Φ} ( {t}_{aj} ) \vert}{{\sum }_{{t}_{1}}^{{t}_{2}} \vert {i}_{diff Φ} ( {t}_{aj} ) \vert} < {P}_{set}\end{matrix} , \qquad ( 8 )$$

herein to is a protection activation moment, t₁ is a first stage moment, t₂ is a second stage moment, t₁ and t₂ are empirical values determined based on an inrush current interruption angle feature, t₁<t₂<20 ms, Pₛₑₜ is an opening coefficient and is an empirical value set to ensure sensitivity to an inter-turn fault; the third criterion results are that: the waveform identification open criterion is satisfied in case that the three-phase differential currents i_{diffΦ}(tₐⱼ) make the formula of the waveform identification open criterion true, or the waveform identification open criterion is not satisfied in case that the three-phase differential currents i_{diffΦ}(tₐⱼ) make the formula of the waveform identification open criterion false.

The fourth criterion unit is configured to respectively determine the fourth criterion results of the three phases according to the fundamental phasors ΔI_{diffΦ±}(tₐⱼ) and the sequence differential current open criterion which is preset, herein formulas of the sequence differential current open criterion are formula (9) and formula (10):

$$\vert Δ {I}_{diffmax \pm } ( {t}_{aj} ) + 2 Δ {I}_{diffx \pm } ( {t}_{aj} ) \vert < {k}_{2} \vert Δ {I}_{diffmax \pm } ( {t}_{aj} ) \vert , and \qquad ( 9 )$$

$$\vert Δ {I}_{diffmax \pm } ( {t}_{aj} ) + 2 Δ {I}_{diffy \pm } ( {t}_{aj} ) \vert < {k}_{2} \vert Δ {I}_{diffmax \pm } ( {t}_{aj} ) \vert , \qquad ( 10 )$$

herein ΔI_{diffmax±}(tₐⱼ)=max{ΔI_{diffA±}(tₐⱼ), ΔI_{diffB±}(tₐⱼ)ΔI_{diffC±}(tₐⱼ)}, ΔI_{diffx±}(tₐⱼ) and ΔI_{diffy±}(tₐⱼ) are the fundamental phasors of the positive and negative sequence component sums of the differential current variations of the remaining two phases other than ΔI_{diffmax±}(tₐⱼ) among the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ), k₂<1; the fourth criterion results are that: the phase corresponding to ΔI_{diffmax±}(tₐⱼ) among the three phases satisfies the sequence differential current open criterion and the remaining two phases do not satisfy the sequence differential current open criterion in case that the two formulas of the sequence differential current open criterion are both true; or none of the three phases satisfies the sequence differential current open criterion in case that either one of the two formulas of the sequence differential current open criterion is false.

In some embodiments, the protection action unit determining output results of respective inter-turn protection actions according to the first criterion results, the second criterion results, the third criterion results, and the fourth criterion results of the three phases includes that:
in case that the first criterion result of a phase among the three phases is that the differential protection criterion is satisfied and the second criterion result of the phase is that the second harmonic blocking criterion is not satisfied, an inter-turn protection action outlet of the phase is determined, or in case that the first criterion result of a phase among the three phases is that the differential protection criterion is satisfied, the second criterion result of the phase is that the second harmonic blocking criterion is satisfied, the third criterion result of the phase is that the waveform identification open criterion is satisfied, and the fourth criterion result of the phase is that the sequence differential current open criterion is satisfied, an inter-turn protection action outlet of the phase is determined.

The inter-turn protection method and system for a converter transformer provided in the technical solution of the present disclosure acquire three-phase currents of a grid side and a valve side of a converter transformer before and after activation of inter-turn protection; calculate three-phase differential currents, three-phase differential current variations, and fundamental phasors of positive and negative sequence component sums of the three-phase differential current variations of the converter transformer according to the three-phase currents; determine criterion results of a differential protection criterion, a second harmonic blocking criterion, a waveform identification open criterion, and a sequence differential current open criterion according the parameter values calculated above; and finally determine, according to the criterion results, whether inter-turn protection acts. The method and system can quickly perform an inter-turn protection action outlet when a developing inter-turn short-circuit fault occurs in a converter transformer and differential protection cannot quickly identify and isolate the fault due to a long second harmonic blocking time, thereby greatly improving sensitivity and action speed of protection when an inter-turn faults occurs.

### BRIEF DESCRIPTION OF THE DRAWINGS

In order to describe the technical solutions in the specific implementations of the present disclosure or in the prior art more clearly, accompanying drawings to be used for description of the specific implementations or the prior art will be briefly introduced below. It is apparent that the accompanying drawings in the following description are merely some implementations of the present disclosure. Those of ordinary skill in the art can further obtain other accompanying drawings according to these accompanying drawings without the exercise of inventive effort.

FIG. 1 is a flowchart of an inter-turn protection method for a converter transformer according to an embodiment of the present disclosure;

FIG. 2 is a schematic diagram of a short-circuit fault between turns of a winding of a grid side of a converter transformer according to an embodiment of the present disclosure;

FIG. 3 is a schematic diagram of waveforms of three-phase differential currents of a converter transformer according to an embodiment of the present disclosure;

FIG. 4 is a schematic diagram of waveforms of positive and negative sequence components of three-phase differential current variations of a converter transformer according to an embodiment of the present disclosure;

FIG. 5 is a logic diagram of criteria of inter-turn protection of a converter transformer according to an embodiment of the present disclosure;

FIG. 6 is a schematic diagram of an inter-turn protection action outlet for phase A of a converter transformer according to an embodiment of the present disclosure;

FIG. 7 is a schematic diagram of an inter-turn protection action outlet for phase B of a converter transformer according to an embodiment of the present disclosure;

FIG. 8 is a schematic diagram of an inter-turn protection action outlet for phase C of a converter transformer according to an embodiment of the present disclosure;

FIG. 9 is a schematic structural diagram of an inter-turn protection system for a converter transformer according to an embodiment of the present disclosure; and

FIG. 10 is a schematic structural diagram of a criterion result unit according to an embodiment of the present disclosure.

### DETAILED DESCRIPTION

Exemplary implementations of the present disclosure will now be described with reference to the accompanying drawings. However, the present disclosure may be implemented in many different forms and is not limited to the embodiments described herein. These embodiments are provided to thoroughly and completely disclose the present disclosure, and to fully convey the scope of the present disclosure to those skilled in the art. The terminology used in the exemplary implementations illustrated in the accompanying drawings is not to limit the present disclosure. In the accompanying drawings, the same units/elements are represented by the same reference signs.

Unless otherwise stated, the terms (including technical and scientific terms) used herein have the same meaning as commonly understood by those skilled in the art to which the present disclosure belongs. Furthermore, it can be understood that terms defined in commonly used dictionaries should be interpreted as having the meanings consistent with the meanings thereof in the context of the related art, and should not be interpreted in an idealized or overly formal sense.

### Embodiment 1

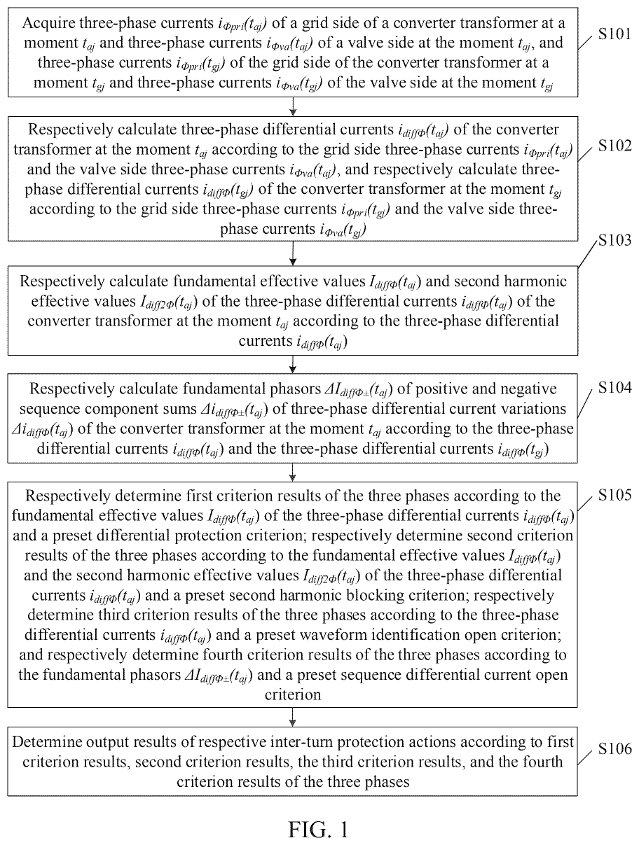

FIG. 1 is a flowchart of an inter-turn protection method for a converter transformer according to an embodiment of the present disclosure. As illustrated in FIG. 1, the inter-turn protection method for a converter transformer begins at operation 101.

In operation 101, three-phase currents i_{Φpri}(tₐⱼ) of a grid side of a converter transformer at a moment tₐⱼ and three-phase currents i_{Φva}(tₐⱼ) of a valve side at the moment tₐⱼ, and three-phase currents i_{Φpri}(t_{gj}) of the grid side of the converter transformer at a moment t_{gj} and three-phase currents i_{Φva}(tₐⱼ) of the valve side at the moment tₐⱼ are acquired. Herein, Φ represents three phases A, B, and C of the converter transformer; t_{gj} is a j-th sampling moment of a time window before activation of inter-turn protection; tₐⱼ is a j-th sampling moment of an a-th time window after activation of inter-turn protection; N is the total number of sampling moments in one time window, a≥1, 1≤j≤N, a, j and N are all natural numbers; and positive directions of the three-phase currents i_{Φpri}(tₐⱼ), i_{Φva}(tₐⱼ), i_{Φpri}(t_{gj}), and i_{Φva}(t_{gj}) are all directed to the inside of the transformer.

In some embodiments, the currents are acquired in time windows. In each time window, a fixed number of sampling moments are taken according to time intervals. The time window may be 20 ms. A time interval for sampling in the time window is 0.8333 s, and the total number of sampling moments is 24. Any one of the three phases of any converter transformer may be faulty, so that during acquiring the currents from the grid side and the valve side of the converter transformer, it is necessary to acquire current from each of the three phases.

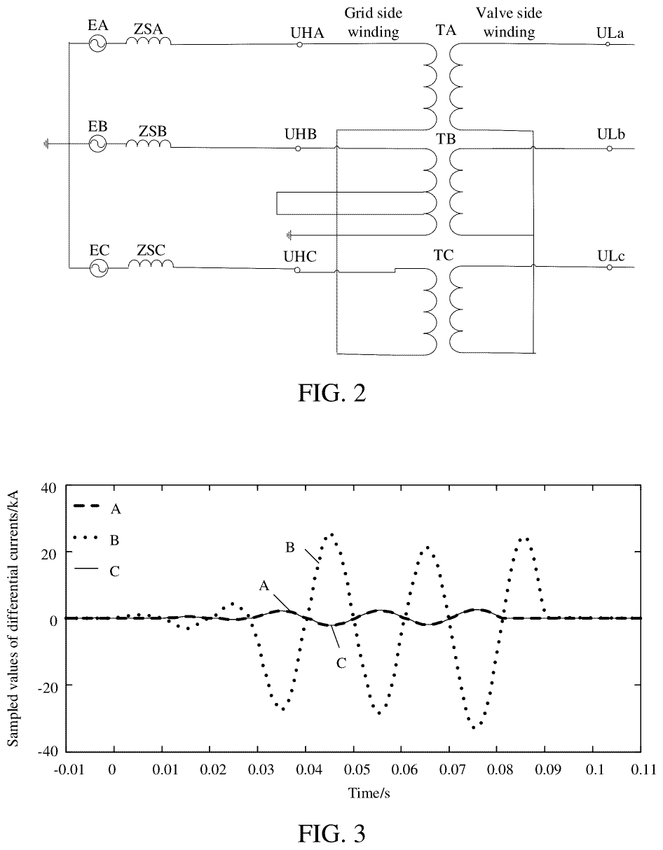

FIG. 2 is a schematic diagram of a short-circuit fault between turns of a winding of a grid side of a converter transformer according to an embodiment of the present disclosure. As illustrated in FIG. 2, a short-circuit fault occurs in phase B of the grid side of the converter transformer.

In operation 102, three-phase differential currents i_{diffΦ}(tₐⱼ) of the converter transformer at the moment tₐⱼ are respectively calculated according to the three-phase currents i_{Φpri}(tₐⱼ) of the grid side and the three-phase currents i_{Φva}(tₐⱼ) of the valve side; and three-phase differential currents i_{diffΦ}(tₐⱼ) of the converter transformer at the moment tₐⱼ are respectively calculated according to the three-phase currents i_{Φpri}(t_{gj}) of the grid side and the three-phase currents i_{Φva}(tₐⱼ) of the valve side.

In some embodiments, the three-phase differential currents i_{diffΦ}(tₐⱼ) of the converter transformer at the moment tₐⱼ are respectively calculated according to the three-phase currents i_{Φpri}(tₐⱼ) of the grid side and the three-phase currents i_{Φva}(tₐⱼ) of the valve side; and the three-phase differential currents i_{diffΦ}(tₐⱼ) of the converter transformer at the moment tₐⱼ are respectively calculated according to the three-phase currents i_{Φpri}(t_{gj}) of the grid side and the three-phase currents i_{Φva}(t_{gj}) of the valve side, herein calculation formulas of the three-phase differential currents i_{diffΦ}(tₐⱼ) and i_{diffΦ}(t_{gj}) are respectively formula (1) and formula (2):

$${i}_{diff Φ} ( {t}_{aj} ) = {i}_{Φ pri} ( {t}_{aj} ) + {i}_{Φ va} ( {t}_{aj} ) \div ratio \qquad ( 1 )$$

$${i}_{diff Φ} ( {t}_{gj} ) = {i}_{Φ pri} ( {t}_{gj} ) + {i}_{Φ va} ( {t}_{gj} ) \div ratio \qquad ( 2 )$$

herein, Φ is the three phases A, B, and C, and the ratio is a converter transformer ratio.

FIG. 3 is a schematic diagram of waveforms of three-phase differential currents of a converter transformer according to an embodiment of the present disclosure. As illustrated in FIG. 3, due to an inter-turn short-circuit fault occurring in phase B of the grid side, taking the moment in case that an inter-turn protection is activated as the 0 moment, it can be observed that the change in the waveform of the differential current for phase B is large. However, since phase A and phase C operate normally, the changes in the waveforms of the differential currents thereof are small, and are almost identical.

In operation 103, fundamental effective values I_{diffΦ}(tₐⱼ) and second harmonic effective values I_{diff2Φ}(tₐⱼ) of the three-phase differential currents i_{diffΦ}(tₐⱼ) of the converter transformer at the moment tₐⱼ are respectively calculated according to the three-phase differential currents i_{diffΦ}(tₐⱼ).

In the prior art, the technique for calculating fundamental effective values and second harmonic effective values of three-phase differential currents of a converter transformer according to the three-phase differential currents has been well established, and the prior art is used in the present disclosure, so that the technique will not be described in detail.

In operation 104, fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ are respectively calculated according to the three-phase differential currents i_{diffΦ}(tₐⱼ) and the three-phase differential currents i_{diffΦ}(t_{gj}).

In some embodiments, the operation of respectively calculating fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}), includes that:
the three-phase differential current variations Δi_{diffΦ}(tₐⱼ) of the converter transformer at the moment tₐⱼ are respectively calculated according to the three-phase differential currents i_{diffΦ}(tₐⱼ) and i_{diffΦ}(t_{gj}), and a calculation formula of the three-phase differential current variations Δi_{diffΦ}(tₐⱼ) is formula (3):

$$Δ {i}_{diff Φ} ( {t}_{aj} ) = {i}_{diff Φ} ( {t}_{aj} ) - {i}_{diff Φ} ( {t}_{gj} ) ; \qquad ( 3 )$$

a zero-sequence component Δi_{diff0}(tₐⱼ) of the three-phase differential current variations Δi_{diffΦ}(tₐⱼ) of the converter transformer at the moment tₐⱼ is calculated according to the three-phase differential current variations Δi_{diffΦ}(tₐⱼ), and a calculation formula of the zero-sequence component Δi_{diffΦ}(tₐⱼ) is formula (4):

$$Δ {i}_{diff 0} ( {t}_{aj} ) = [ Δ {i}_{diffA} ( {t}_{aj} ) + Δ {i}_{diff B} ( {t}_{aj} ) + Δ {i}_{diffC} ( {t}_{aj} ) ] \div 3 ; \qquad ( 4 )$$

the positive and negative sequence component sums ΔI_{diffΦ±}(tₐⱼ) of the three-phase differential current variations Δi_{diffΦ}(tₐⱼ) of the converter transformer at the moment tₐⱼ are respectively calculated according to the three-phase differential current variations Δi_{diffΦ}(tₐⱼ) and the zero-sequence component Δi_{diff0}(tₐⱼ), and a calculation formula of the positive and negative sequence component sums Δi_{diffΦ±}(tₐⱼ) is formula (5):

$$Δ {i}_{diffΦ \pm } ( {t}_{aj} ) = Δ {i}_{diffΦ} ( {t}_{aj} ) - Δ {i}_{diff 0} ( {t}_{aj} ) ; \qquad ( 5 )$$

the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ) of the converter transformer at the moment tₐⱼ are respectively calculated according to the positive and negative sequence component sums Δi_{diffΦ±}(tₐⱼ) of the three-phase differential current variations Δi_{diffΦ}(tₐⱼ).

In operation 105, first criterion results of the three phases are respectively determined according to the fundamental effective values I_{diffΦ}(tₐⱼ) of the three-phase differential currents i_{diffΦ}(tₐⱼ) and a differential protection criterion which is preset; second criterion results of the three phases are respectively determined according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset; third criterion results of the three phases are respectively determined according to the three-phase differential currents i_{diffΦ}(tₐⱼ) and a waveform identification open criterion which is preset; and fourth criterion results of the three phases are respectively determined according to the fundamental phasors ΔI_{diffΦ±}(tₐⱼ) and a sequence differential current open criterion which is preset; and

In some embodiments, for the operations of respectively determining first criterion results of the three phases according to the fundamental effective values I_{diffΦ}(tₐⱼ) of the three-phase differential currents i_{diffΦ}(tₐⱼ) and a differential protection criterion which is preset, respectively determining second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset, respectively determining third criterion results of the three phases according to the three-phase differential currents i_{diffΦ}(tₐⱼ) and a waveform identification open criterion which is preset, and respectively determining fourth criterion results of the three phases according to the fundamental phasors ΔI_{diffΦ±}(tₐⱼ) and a sequence differential current open criterion which is preset, in which:
a formula of the differential protection criterion is formula (6):

$$\{ \begin{matrix}{I}_{diff ϕ} ( {t}_{aj} ) > {I}_{cdqd} & {I}_{r e s ϕ} ( {t}_{aj} ) \leq {I}_{res 0} \\ {I}_{diff ϕ} ( {t}_{aj} ) > {I}_{cdqd} + {k}_{0} ( {I}_{res ϕ} ( {t}_{aj} ) - {I}_{res 0} ) & {I}_{res ϕ} ( {t}_{aj} ) > {I}_{res 0}\end{matrix} , \qquad ( 6 )$$

herein I_{resΦ}(tₐⱼ)=|i_{Φpri}(tₐⱼ)−i_{Φva}(tₐⱼ)÷ratio|/2, Iᵣₑₛ₀ and k₀ are both constants, I_{cdqd} is a preset first coefficient, the first criterion results are that: the differential protection criterion is satisfied in case that the formula of the differential protection criterion is true, or the differential protection criterion is not satisfied in case that the formula of the differential protection criterion is false;
a formula of the second harmonic blocking criterion is formula (7):

$${I}_{diff 2 Φ} ( {t}_{aj} ) > {k}_{1} {I}_{diff Φ} ( {t}_{aj} ) , \qquad ( 7 )$$

herein k₁ is a preset second coefficient, the second criterion results are that: the second harmonic blocking criterion is satisfied in case that the formula of the second harmonic blocking criterion is true, or the second harmonic blocking criterion is not satisfied in case that the formula of the second harmonic blocking criterion is false.

In the prior art, the formulas of the differential protection criterion and the second harmonic blocking criterion of the converter transformer may be expressed in multiple manners depending on different application scenarios, and only one of the manners is provided in the present disclosure, and does not represent any limitation on the differential protection criterion or the second harmonic blocking criterion of the present disclosure. The technical solution of using any differential protection criterion and any second harmonic blocking criterion in the prior art in combination with the other criteria in the present disclosure to solve the technical problem of the present disclosure so as to achieve the technical effect of the present disclosure falls within the scope of protection of the present disclosure.

A formula of the waveform identification open criterion is formula (8):

$$\{ \begin{matrix}{I}_{diff ϕ} ( {t}_{2} ) > {I}_{cdqd} \\ \frac{{\sum }_{{t}_{0}}^{{t}_{1}} \vert {i}_{diff Φ} ( {t}_{aj} ) \vert}{{\sum }_{{t}_{1}}^{{t}_{2}} \vert {i}_{diff Φ} ( {t}_{aj} ) \vert} < {P}_{set}\end{matrix} , \qquad ( 8 )$$

herein t₀ is a protection activation moment, t₁ is a first stage moment, t₂ is a second stage moment, t₁ and t₂ are empirical values determined based on an inrush current interruption angle feature, t₁<t₂<20 ms, Pₛₑₜ is an opening coefficient and is an empirical value set to ensure sensitivity to an inter-turn fault; the third criterion results are that: the waveform identification open criterion is satisfied in case that the three-phase differential currents i_{diffΦ}(tₐⱼ) make the formula of the waveform identification open criterion true, or the waveform identification open criterion is not satisfied in case that the three-phase differential currents i_{diffΦ}(tₐⱼ) make the formula of the waveform identification open criterion false.

Formulas of the sequence differential current open criterion are formula (9) and formula (10):

$$\vert Δ {I}_{diffmax \pm } ( {t}_{a j} ) + 2 Δ {I}_{diffx \pm } ( {t}_{aj} ) \vert < {k}_{2} \vert Δ {I}_{diffmax \pm } ( {t}_{aj} ) \vert , \qquad ( 9 )$$

$$and$$

$$\vert Δ {I}_{diffmax \pm } ( {t}_{a j} ) + 2 Δ {I}_{diffy \pm } ( {t}_{aj} ) \vert < {k}_{2} \vert Δ {I}_{diffmax \pm } ( {t}_{aj} ) \vert , \qquad ( 10 )$$

herein ΔI_{diffmax±}(tₐⱼ)=max{ΔI_{diffA±}(tₐⱼ), ΔI_{diffB±}(tₐⱼ), ΔI_{diffC±}(tₐⱼ)}, ΔI_{diffx±}(tₐⱼ) and ΔI_{diffy±}(tₐⱼ) are the fundamental phasors of the positive and negative sequence component sums of the differential current variations of the remaining two phases other than ΔI_{diffmax±}(tₐⱼ) among the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ), k₂<1; the fourth criterion results are that: the phase corresponding to ΔI_{diffmax±}(tₐⱼ) among the three phases satisfies the sequence differential current open criterion and the remaining two phases do not satisfy the sequence differential current open criterion in case that the two formulas of the sequence differential current open criterion are both true; or none of the three phases satisfies the sequence differential current open criterion in case that either one of the two formulas of the sequence differential current open criterion is false.

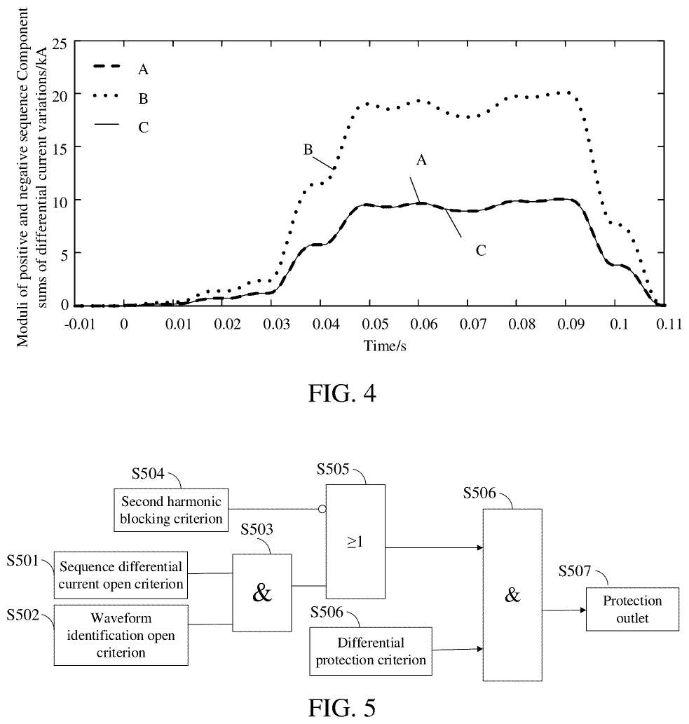

FIG. 4 is a schematic diagram of waveforms of positive and negative sequence components of three-phase differential current variations of a converter transformer according to an embodiment of the present disclosure. As illustrated in FIG. 4, the waveform of the positive and negative sequence component sum of the differential current variation for phase B have the largest amplitude among the three phases. Thus, in some embodiments, ΔI_{diffmax±}(tₐⱼ) is the fundamental phasor of the positive and negative sequence component sum of the three-phase differential current variation for phase B.

In operation 106, output results of respective inter-turn protection actions are determined according to the first criterion results, the second criterion results, the third criterion results, and the fourth criterion results of the three phases.

In some embodiments, the operation of determining output results of respective inter-turn protection actions according to the first criterion results, the second criterion results, the third criterion results, and the fourth criterion results of the three phases includes that:
in case that the first criterion result of a certain phase among the three phases is that the differential protection criterion is satisfied and the second criterion result of this phase is that the second harmonic blocking criterion is not satisfied, an inter-turn protection action outlet of this phase is determined; or in case that the first criterion result of a certain phase among the three phases is that the differential protection criterion is satisfied, the second criterion result of this phase is that the second harmonic blocking criterion is satisfied, the third criterion result of this phase is that the waveform identification open criterion is satisfied, and the fourth criterion result of this phase is that the sequence differential current open criterion is satisfied, an inter-turn protection action outlet of this phase is determined.

FIG. 5 is a logic diagram of criteria of inter-turn protection of a converter transformer according to an embodiment of the present disclosure. As illustrated in FIG. 5, for each one of three phases of a converter transformer, a sequence differential current open criterion in S501 and a waveform identification open criterion in S502 perform an AND operation in S503. This result is then forms an OR relationship with the result that a second harmonic blocking criterion in S504 performs an NOT operation in S505; so that in case that a differential protection criterion in S506 is satisfied, but the second harmonic blocking criterion in S504 is not satisfied, or although the second harmonic blocking criterion in S504 is satisfied, but both the sequence differential current open criterion in S501 and the waveform identification open criterion in S502 are both satisfied, and the differential protection criterion in S506 is also satisfied, an inter-turn protection action outlet in S507 is performed.

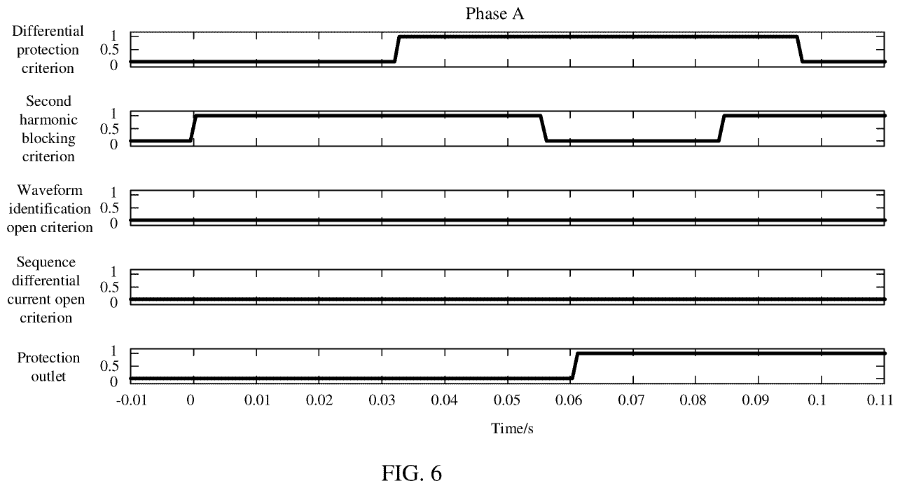

FIG. 6 is a schematic diagram of an inter-turn protection action outlet for phase A of a converter transformer according to an embodiment of the present disclosure. As illustrated in FIG. 6, after activation of inter-turn protection, at 33 ms, the logic value of the differential protection criterion for phase A is 1, and the first criterion result is that the differential protection criterion is satisfied. At 56 ms, the logic value of the second harmonic blocking criterion is 0, and the second criterion result is that the second harmonic blocking criterion is not satisfied, but the logic values of the waveform identification open criterion and the sequence differential current open criterion are both 0, so that at 56 ms, the differential protection criterion is satisfied, but the second harmonic blocking criterion is not satisfied, which conforms to the case of the inter-turn protection action outlet. Therefore, at 61 ms, the inter-turn protection action outlet for phase A is performed.

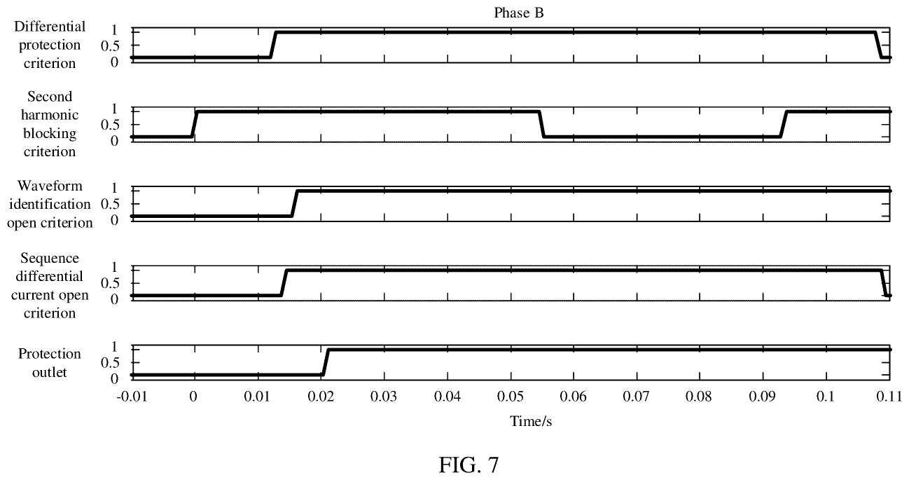

FIG. 7 is a schematic diagram of an inter-turn protection action outlet for phase B of a converter transformer according to an embodiment of the present disclosure. As illustrated in FIG. 7, after activation of inter-turn protection, at 13 ms, the logic value of the differential protection criterion for phase B is 1, and the first criterion result is that the differential protection criterion is satisfied. From 0 to 56 ms, the logic value of the second harmonic blocking criterion is 1, and the second criterion result is that the second harmonic blocking criterion is satisfied, but the logic values of the waveform identification open criterion and the sequence differential current open criterion change from 0 to 1 at 15 ms. That is, at 15 ms, the third criterion result is that the waveform identification open criterion is satisfied, and the fourth criterion result is that the sequence differential current open criterion is satisfied. Therefore, at 15 ms, the differential protection criterion is satisfied, and the waveform identification open criterion and the sequence differential current open criterion are also satisfied, which conforms to the case of the inter-turn protection action outlet. Finally, at 20 ms, the inter-turn protection action outlet for phase B is performed.

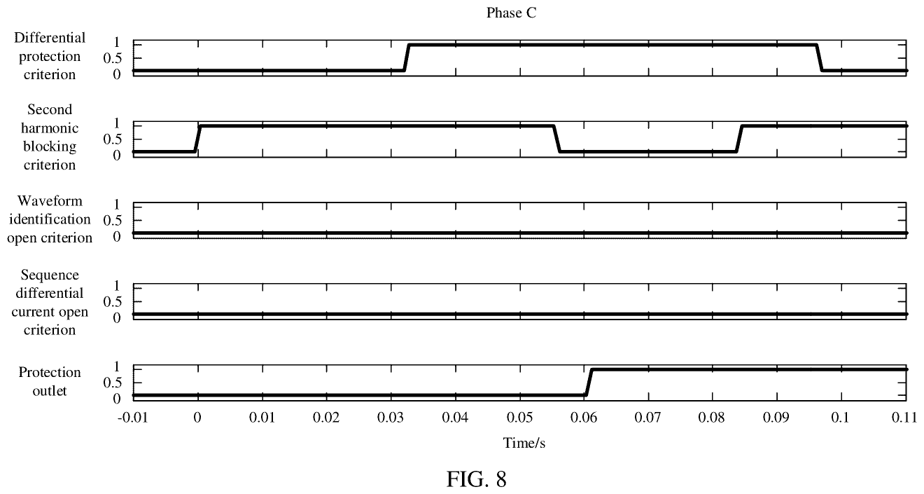

FIG. 8 is a schematic diagram of an inter-turn protection action outlet for phase C of a converter transformer according to an embodiment of the present disclosure. As illustrated in FIG. 8, the logic determination result is the same as the logic determination result for phase A in FIG. 6. After activation of inter-turn protection, at 33 ms, the logic value of the differential protection criterion for phase C is 1, and the first criterion result is that the differential protection criterion is satisfied. At 56 ms, the logic value of the second harmonic blocking criterion is 0, and the second criterion result is that the second harmonic blocking criterion is not satisfied, but the logic values of the waveform identification open criterion and the sequence differential current open criterion are both 0; so that at 56 ms, the differential protection criterion is satisfied, but the second harmonic blocking criterion is not satisfied, which conforms to the case of the inter-turn protection action outlet. Finally, at 61 ms, the inter-turn protection action outlet for phase C is performed.

As can be seen from FIG. 6, FIG. 7 and FIG. 8, in case that an inter-turn short-circuit fault occurs in phase B of the converter transformer, the method of the present disclosure needs only 20 ms to achieve the inter-turn protection action outlet for phase B compared with the conventional method of determining, according to differential protection criterion and second harmonic blocking criterion, whether the inter-turn protection action outlet is to be performed. However, in the conventional method, the inter-turn protection action outlet time for phase B is the same as those for phase A and phase B, that is, the inter-turn protection action outlet time for phase B is performed at 61 ms, which is obviously slower than the inter-turn protection action outlet time of the method of the present disclosure. Therefore, the use of the inter-turn protection method of the present disclosure can greatly improve sensitivity and action speed of protection when an inter-turn faults occurs.

### Embodiment 2

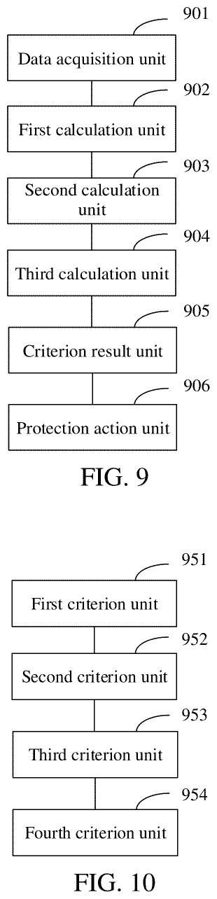

FIG. 9 is a schematic structural diagram of an inter-turn protection system for a converter transformer according to an embodiment of the present disclosure. As illustrated in FIG. 9, the inter-turn protection system for a converter transformer includes a data acquisition unit 901, a first calculation unit 902, a second calculation unit 903, a third calculation unit 904, a criterion result unit 905 and a protection action unit 906.

The data acquisition unit 901 is configured to acquire: three-phase currents i_{Φpri}(tₐⱼ) of a grid side of a converter transformer at a moment tₐⱼ and three-phase currents i_{Φva}(tₐⱼ) of a valve side at the moment tₐⱼ, and three-phase currents i_{Φpri}(t_{gj}) of the grid side of the converter transformer at a moment t_{gj} and three-phase currents i_{Φva}(t_{gj}) of the valve side at the moment t_{gj}. Herein, Φ represents three phases A, B, and C of the converter transformer, t_{gj} is a j-th sampling moment of a time window before activation of inter-turn protection, tₐⱼ is a j-th sampling moment of an a-th time window after activation of inter-turn protection, N is the total number of sampling moments in one time window, a≥1, 1≤j≤N, a, j, and N are all natural numbers, and positive directions of the three-phase currents i_{Φpri}(tₐⱼ), i_{Φva}(tₐⱼ), i_{Φpri}(t_{gj}), and i_{Φva}(t_{gj}) are all directed to the inside of the transformer.

The first calculation unit 902 is configured to: respectively calculate three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side; and respectively calculate three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side.

The second calculation unit 903 is configured to respectively calculate fundamental effective values I_{diffΦ}(tₐⱼ) and second harmonic effective values I_{diff2Φ}(tₐⱼ) of the three-phase differential currents i_{diffΦ}(tₐⱼ) of the converter transformer at the moment tₐⱼ according to the three-phase differential currents i_{diffΦ}(tₐⱼ).

The third calculation unit 904 is configured to: respectively calculate fundamental phasors ΔI_{diffΦ±}(tₐⱼ) of positive and negative sequence component sums Δi_{diffΦ}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}).

The criterion result unit 905 is configured to: respectively determine first criterion results of the three phases according to the fundamental effective values i_{diffΦ}(tₐⱼ) of the three-phase differential currents i_{diffΦ}(tₐⱼ) and a differential protection criterion which is preset; respectively determine second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset; respectively determine third criterion results of the three phases according to the three-phase differential currents i_{diffΦ}(tₐⱼ) and a waveform identification open criterion which is preset; and respectively determine fourth criterion results of the three phases according to the fundamental phasors ΔI_{diffΦ±}(tₐⱼ) and a sequence differential current open criterion which is preset.

The protection action unit 906 is configured to determine output results of respective inter-turn protection actions according to the first criterion results, the second criterion results, the third criterion results, and the fourth criterion results of the three phases.

In some embodiments, the first calculation unit 902 respectively calculates three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side, and respectively calculates three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side, herein calculation formulas of the three-phase differential currents i_{diffΦ}(tₐⱼ) and i_{diffΦ}(t_{gj}) are respectively formula (1) and formula (2):

$${i}_{diff Φ} ( {t}_{aj} ) = {i}_{Φ pri} ( {t}_{aj} ) + {i}_{Φ v a} ( {t}_{aj} ) \div ratio , \qquad ( 1 )$$

$$and$$

$${i}_{diff Φ} ( {t}_{gj} ) = {i}_{Φ pri} ( {t}_{gj} ) + {i}_{Φ v a} ( {t}_{gj} ) \div ratio , \qquad ( 2 )$$

herein Φ is the three phases A, B, and C, and the ratio is a converter transformer ratio.

In some embodiments, the third calculation unit 904 respectively calculating fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}) includes that:
the three-phase differential current variations Δi_{diffΦ}(tₐⱼ) of the converter transformer at the moment tₐⱼ are respectively calculated according to the three-phase differential currents i_{diffΦ}(tₐⱼ) and i_{diffΦ}(t_{gj}), and a calculation formula of the three-phase differential current variations Δi_{diffΦ}(tₐⱼ) is formula (3):

$$Δ {i}_{diff Φ} ( {t}_{aj} ) = {i}_{diff Φ} ( {t}_{aj} ) - {i}_{diff Φ} ( {t}_{gi} ) ; \qquad ( 3 )$$

a zero-sequence component Δi_{diff0}(tₐⱼ) of the three-phase differential current variations Δi_{diffΦ}(tₐⱼ) of the converter transformer at the moment tₐⱼ is calculated according to the three-phase differential current variations Δi_{diffΦ}(tₐⱼ), and a calculation formula of the zero-sequence component Δi_{diff0}(tₐⱼ) is formula (4):

$$Δ {i}_{diff 0} ( {t}_{aj} ) = [ Δ {i}_{diff A} ( {t}_{aj} ) + Δ {i}_{diff B} ( {t}_{aj} ) + Δ {i}_{diff C} ( {t}_{aj} ) ] \div 3 ; \qquad ( 4 )$$

the positive and negative sequence component sums Δi_{diffΦ±}(tₐⱼ) of the three-phase differential current variations Δi_{diffΦ}(tₐⱼ) of the converter transformer at the moment tₐⱼ are respectively calculated according to the three-phase differential current variations Δi_{diffΦ}(tₐⱼ) and the zero-sequence component Δi_{diffΦ}(tₐⱼ), and a calculation formula of the positive and negative sequence component sums Δi_{diffΦ±}(tₐⱼ) is formula (5):

$$Δ {i}_{diff Φ \pm } ( {t}_{aj} ) = Δ {i}_{diff Φ} ( {t}_{aj} ) - Δ {i}_{diff 0} ( {t}_{aj} ) ; \qquad ( 5 )$$

the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ) of the converter transformer at the moment tₐⱼ are respectively calculated according to the positive and negative sequence component sums Δi_{diffΦ±}(tₐⱼ) of the three-phase differential current variations Δi_{diffΦ}(tₐⱼ).

In some embodiments, the criterion result unit 905 includes a first criterion unit 951, a second criterion unit 952, a third criterion unit 953 and a fourth criterion unit 954.

The first criterion unit 951 is configured to respectively determine the first criterion results of the three phases according to the fundamental effective values I_{diffΦ}(tₐⱼ) of the three-phase differential currents i_{diffΦ}(tₐⱼ) and the differential protection criterion which is present, herein a formula of the differential protection criterion is formula (6):

$$\{ \begin{matrix}{I}_{diff ϕ} ( {t}_{aj} ) > {I}_{cdqd} & {I}_{res ϕ} ( {t}_{aj} ) \leq {I}_{res 0} \\ {I}_{diff ϕ} ( {t}_{aj} ) > {I}_{cdqd} + {k}_{0} ( {I}_{res ϕ} ( {t}_{aj} ) - {I}_{res 0} ) & {I}_{res ϕ} ( {t}_{aj} ) > {I}_{res 0}\end{matrix} , \qquad ( 6 )$$

herein I_{resΦ}(tₐⱼ)=|i_{Φpri}(tₐⱼ)−i_{Φva}(tₐⱼ)÷ratio|/2, Iᵣₑₛ₀ and k₀ are both constants, I_{cdqd} is a preset first coefficient, the first criterion results are that: the differential protection criterion is satisfied in case that the formula of the differential protection criterion is true, or the differential protection criterion is not satisfied in case that the formula of the differential protection criterion is false.

The second criterion unit 952 is configured to respectively determine the second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and the second harmonic blocking criterion which is preset, herein a formula of the second harmonic blocking criterion is formula (7):

$${I}_{diff 2 Φ} ( {t}_{aj} ) > {k}_{1} {I}_{diff Φ} ( {t}_{aj} ) , \qquad ( 7 )$$

herein k₁ is a preset second coefficient, the second criterion results are that: the second harmonic blocking criterion is satisfied in case that the formula of the second harmonic blocking criterion is true, or the second harmonic blocking criterion is not satisfied in case that the formula of the second harmonic blocking criterion is false.

The third criterion unit 953 is configured to respectively determine the third criterion results of the three phases according to the three-phase differential currents i_{diffΦ}(tₐⱼ) and the waveform identification open criterion which is preset, herein a formula of the waveform identification open criterion is formula (8):

$$\{ \begin{matrix}{I}_{diff ϕ} ( {t}_{2} ) > {I}_{cdqd} \\ \frac{{\sum }_{{t}_{0}}^{{t}_{1}} \vert {i}_{diff Φ} ( {t}_{aj} ) \vert}{{\sum }_{{t}_{1}}^{{t}_{2}} \vert {i}_{diff Φ} ( {t}_{aj} ) \vert} < {P}_{set}\end{matrix} , \qquad ( 8 )$$

herein t₀ is a protection activation moment, t₁ is a first stage moment, t₂ is a second stage moment, t₁ and t₂ are empirical values determined based on an inrush current interruption angle feature, t₁<t₂<20 ms, Pₛₑₜ is an open coefficient, and being an empirical value set to ensure sensitivity to an inter-turn fault; the third criterion results are that: the waveform identification open criterion is satisfied in case that the three-phase differential currents i_{diffΦ}(tₐⱼ) make the formula of the waveform identification open criterion true, or the waveform identification open criterion is not satisfied in case that the three-phase differential currents i_{diffΦ}(tₐⱼ) make the formula of the waveform identification open criterion false.

The fourth criterion unit 954 is configured to respectively determine the fourth criterion results of the three phases according to the fundamental phasors ΔI_{diffΦ±}(tₐⱼ) and the sequence differential current open criterion which is preset, herein formulas of the sequence differential current open criterion are formula (9) and formula (10):

$$\vert Δ {I}_{diffmax \pm } ( {t}_{a j} ) + 2 Δ {I}_{diffx \pm } ( {t}_{aj} ) \vert < {k}_{2} \vert Δ {I}_{diffmax \pm } ( {t}_{aj} ) \vert , \qquad ( 9 )$$

$$and$$

$$\vert Δ {I}_{diffmax \pm } ( {t}_{a j} ) + 2 Δ {I}_{diffy \pm } ( {t}_{aj} ) \vert < {k}_{2} \vert Δ {I}_{diffmax \pm } ( {t}_{aj} ) \vert , \qquad ( 10 )$$

herein ΔI_{diffmax±}(tₐⱼ)=max{I_{diffA±}(tₐⱼ), ΔI_{diffB±}(tₐⱼ)ΔI_{diffC±}(ta)}, ΔI_{diffx±}(tₐⱼ) and ΔI_{diffy±}(tₐⱼ) are the fundamental phasors of the positive and negative sequence component sums of the differential current variations of the remaining two phases other than ΔI_{diffmax±}(tₐⱼ) among the fundamental phasors ΔI_{diffΦ±}(tₐⱼ) of the positive and negative sequence component sums Δi_{diffΦ}(tₐⱼ) of the three-phase differential current variations Δi_{diffΦ}(tₐⱼ), k₂<1; the fourth criterion results are that: the phase corresponding to ΔI_{diffmax±}(tₐⱼ) among the three phases satisfies the sequence differential current open criterion and the remaining two phases do not satisfy the sequence differential current open criterion in case that the two formulas of the sequence differential current open criterion are both true; or none of the three phases satisfies the sequence differential current open criterion in case that either one of the two formulas of the sequence differential current open criterion is false.

FIG. 10 is a schematic structural diagram of a criterion result unit according to an embodiment of the present disclosure. As illustrated in FIG. 10, the criterion result unit includes a first criterion unit 951, a second criterion unit 952, a third criterion unit 953, and a fourth criterion unit 954.

In some embodiments, the protection action unit 906 determining output results of respective inter-turn protection actions according to the first criterion results, the second criterion results, the third criterion results, and the fourth criterion results of the three phases includes that:
in case that the first criterion result of a certain phase among the three phases is that the differential protection criterion is satisfied and the second criterion result of this phase is that the second harmonic blocking criterion is not satisfied, an inter-turn protection action outlet of this phase is determined; or in case that the first criterion result of a certain phase among the three phases is that the differential protection criterion is satisfied, the second criterion result of this phase is that the second harmonic blocking criterion is satisfied, the third criterion result of this phase is that the waveform identification open criterion is satisfied, and the fourth criterion result of this phase is that the sequence differential current open criterion is satisfied, an inter-turn protection action outlet of this phase is determined.

In the present disclosure, when an internal short-circuit between turns of a winding of a converter transformer develops rapidly and a transient short-circuit current increases dramatically, the inter-turn protection system configured for a converter transformer acquires three-phase currents of the grid side and the valve side before and after the fault, thereby quickly identifying the inter-turn fault, unlocking the second harmonic blocking, quickly performing differential protection and isolating the fault. The operations performed by the inter-turn protection system are the same as the operations used in the inter-turn protection method for a converter transformer, and the technical effect achieved are also the same, which will not be described herein again.

The present disclosure has been described with reference to a few embodiments. However, it is known to those skilled in the art that embodiments of the present disclosure other than those disclosed above fall equally within the scope of the present disclosure, as defined by the accompanying patent claims.

Generally, all terms used in the claims are to be interpreted according to common meanings thereof in the technical field, unless explicitly defined otherwise therein. All references to “a//the [apparatus, assembly, etc.]” are to be interpreted openly as referring to at least one instance of the apparatus, the assembly, etc., unless explicitly stated otherwise. The operations of any method disclosed herein are not necessarily performed in the exact order disclosed, unless explicitly stated.

It should be apparent to those skilled in the art that the embodiments of the present disclosure may be provided as a method, a system, or a computer program product. Therefore, the present disclosure may take the form entirely of a hardware embodiment, entirely of a software embodiment, or of an embodiment combining software and hardware aspects. Moreover, the present disclosure may take the form of a computer program product implemented on one or more computer-usable storage media (including, but not limited to, a magnetic disk memory, a CD-ROM, an optical memory, etc.) containing computer-usable program codes therein.

The present disclosure is described with reference to flowcharts and/or block diagrams of the methods, devices (systems), and computer program products according to the embodiments of the present disclosure. It should be understood that each process in the flowchart and/or each block in block diagram, and a combination of processes in the flowchart and/or blocks in block diagram may be implemented by computer program instructions. These computer program instructions may be supplied to a processor of a general-purpose computer, a special-purpose computer, an embedded processing machine, or other programmable data processing device to generate a machine such that instructions executed by the processor of the computer or other programmable data processing device generate apparatuses for implementing the functions specified in one or more processes of the flowchart and/or one or more blocks of the block diagram.

These computer program instructions may also be stored in a computer-readable memory capable of directing a computer or other programmable data processing device to operate in a specific manner, such that the instructions stored in the computer-readable memory produce a manufactured article including an instruction apparatus that implements the functions specified in one or more processes of the flowchart and/or one or more blocks of the block diagram.

These computer program instructions may also be loaded onto a computer or other programmable data processing device such that a series of operational operations is performed on the computer or other programmable devices to generate computer-implemented processing, so that the instructions executed on the computer or other programmable devices provide operations for implementing the functions specified in one or more processes of the flowchart and/or one or more blocks of the block diagram.

Finally, the following should be noted: the above embodiments are merely provided for describing the technical solutions of the present disclosure, but not intended to limit the same. Although the present disclosure has been described in detail with reference to the above embodiments, the following should be understood by those of ordinary skill in the art: modifications or equivalent replacements can also be made to the specific implementations of the present disclosure, and any modifications or equivalent replacements that do not depart from the spirit and scope of the present disclosure shall fall within the scope of protection of the claims of the present disclosure.

1. An inter-turn protection method for a converter transformer, comprising:
acquiring three-phase currents i_{Φpri}(tₐⱼ) of a grid side of a converter transformer at a moment tₐⱼ and three-phase currents i_{Φva}(tₐⱼ) of a valve side of the converter transformer at the moment tₐⱼ, and three-phase currents i_{Φpri}(t_{gj}) of the grid side of the converter transformer at a moment t_{gj} and three-phase currents i_{Φva}(t_{gj}) of the valve side at the moment t_{gj}; wherein Φ represents three phases A, B, and C of the converter transformer, t_{gj} is a j-th sampling moment of a time window before activation of inter-turn protection, tₐⱼ is a j-th sampling moment of an a-th time window after the activation of inter-turn protection, N is a total number of sampling moments in one time window, a≥1, 1≤j≤N, a, j, and N are all natural numbers, and positive directions of the three-phase currents i_{Φpri}(tₐⱼ), i_{Φva}(tₐⱼ), i_{Φpri}(t_{gj}), and i_{Φva}(t_{gj}) are all directed to an inside of the converter transformer;
respectively calculating three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side; and respectively calculating three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side;
respectively calculating fundamental effective values I_{diffΦ}(tₐⱼ) and second harmonic effective values I_{diffΦ}(tₐⱼ) of the three-phase differential currents i_{diffΦ}(tₐⱼ) of the converter transformer at the moment tₐⱼ according to the three-phase differential currents i_{diffΦ}(t_{gj});
respectively calculating fundamental phasors ΔI_{diffΦ±}(tₐⱼ) of positive and negative sequence component sums Δi_{diffΦ±}(tₐⱼ) of three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj});
respectively determining first criterion results of the three phases according to the fundamental effective values I_{diffΦ}(tₐⱼ) of the three-phase differential currents i_{diffΦ}(tₐⱼ) and a differential protection criterion which is preset; respectively determining second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset; respectively determining third criterion results of the three phases according to the three-phase differential currents i_{diffΦ}(tₐⱼ) and a waveform identification open criterion which is preset; and respectively determining fourth criterion results of the three phases according to the fundamental phasors ΔI_{diffΦ±}(tₐⱼ) and a sequence differential current open criterion which is preset; and
determining output results of respective inter-turn protection actions according to the first criterion results, the second criterion results, the third criterion results, and the fourth criterion results of the three phases.

2. The method according to claim 1, wherein for the operations of respectively calculating the three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of valve side, and respectively calculating the three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side, calculation formulas of the three-phase differential currents i_{diffΦ}(tₐⱼ) and i_{diffΦ}(t_{gj}) are respectively formula (1) and formula (2):
$${i}_{diff Φ} ( {t}_{aj} ) = {i}_{Φ pri} ( {t}_{aj} ) + {i}_{Φ v a} ( {t}_{aj} ) \div ratio , \qquad ( 1 )$$
$$and$$
$${i}_{diff Φ} ( {t}_{gj} ) = {i}_{Φ p r l} ( {t}_{gj} ) + {i}_{Φ v a} ( {t}_{gj} ) \div ratio , \qquad ( 2 )$$
wherein Φ represents the three phases A, B, and C, and the ratio is a converter transformer ratio.

3. The method according to claim 1, wherein the operation of respectively calculating the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ) of the converter transformer at the moment tₐⱼ according to the three-phase differential currents i_{diffΦ}(tₐⱼ) and the three-phase differential currents i_{diffΦ}(t_{gj}) comprises:
respectively calculating the three-phase differential current variations Δi_{diffΦ}(tₐⱼ) of the converter transformer at the moment tₐⱼ according to the three-phase differential currents i_{diffΦ}(tₐⱼ) and i_{diffΦ}(t_{gj}), a calculation formula of the three-phase differential current variations Δi_{diffΦ}(tₐⱼ) being formula (3):
$$Δ {i}_{diff Φ} ( {t}_{aj} ) = {i}_{diff Φ} ( {t}_{aj} ) - {i}_{diff Φ} ( {t}_{gj} ) ; \qquad ( 3 )$$
calculating a zero-sequence component Δi_{diff0}(tₐⱼ) of the three-phase differential current variations Δi_{diffΦ}(tₐⱼ) of the converter transformer at the moment tₐⱼ according to the three-phase differential current variations Δi_{diffΦ}(tₐⱼ), a calculation formula of the zero-sequence component Δi_{diff0}(tₐⱼ) being formula (4):
$$Δ {i}_{diff 0} ( {t}_{aj} ) = [ Δ {i}_{diffA} ( {t}_{aj} ) + Δ {i}_{diffB} ( {t}_{aj} ) + Δ {i}_{diffC} ( {t}_{aj} ) ] \div 3 ; \qquad ( 4 )$$
respectively calculating the positive and negative sequence component sums Δi_{diffΦ±}(tₐⱼ) of the three-phase differential current variations Δi_{diffΦ}(tₐⱼ) of the converter transformer at the moment tₐⱼ according to the three-phase differential current variations Δi_{diffΦ±}(tₐⱼ) and the zero-sequence component Δi_{diff0}(tₐⱼ), a calculation formula of the positive and negative sequence component sums Δi_{diffΦ±}(tₐⱼ) being formula (5):
$$Δ {i}_{diff Φ \pm } ( {t}_{aj} ) = Δ {i}_{diff Φ} ( {t}_{aj} ) - Δ {i}_{diff 0} ( {t}_{aj} ) ; \qquad ( 5 )$$
respectively calculating the fundamental phasors ΔI_{diffΦ±}(tₐⱼ) of the positive and negative sequence component sums Δi_{diffΦ±}(tₐⱼ) of the three-phase differential current variations ΔI_{diffΦ}(tₐⱼ) of the converter transformer at the moment tₐⱼ according to the positive and negative sequence component sums Δi_{diffΦ±}(tₐⱼ) of the three-phase differential current variations Δi_{diffΦ}(tₐⱼ).

4. The method according to claim 3, wherein for the operations of respectively determining the first criterion results of the three phases according to the fundamental effective values I_{diffΦ}(tₐⱼ) of the three-phase differential currents i_{diffΦ}(tₐⱼ) and the preset differential protection criterion, respectively determining the second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and the preset second harmonic blocking criterion, respectively determining the third criterion results of the three phases according to the three-phase differential currents i_{diffΦ}(tₐⱼ) and the preset waveform identification open criterion, and respectively determining the fourth criterion results of the three phases according to the fundamental phasors ΔI_{diffΦ±}(tₐⱼ) and the preset sequence differential current open criterion,
a formula of the differential protection criterion is formula (6):
$$\{ \begin{matrix}{I}_{diff ϕ} ( {t}_{aj} ) > {I}_{cdqd} & {I}_{res ϕ} ( {t}_{aj} ) \leq {I}_{res 0} \\ {I}_{diff ϕ} ( {t}_{aj} ) > {I}_{cdqd} + {k}_{0} ( {I}_{res ϕ} ( {t}_{aj} ) - {I}_{res 0} ) & {I}_{res ϕ} ( {t}_{aj} ) > {I}_{res 0}\end{matrix} , \qquad ( 6 )$$
wherein I_{resΦ}(tₐⱼ)=|i_{Φpri}(tₐⱼ)−i_{Φva}(tₐⱼ)÷ratio|/2, Iᵣₑₛ₀ and k₀ are both constants, I_{cdqd} is a preset first coefficient, the first criterion results are that: the differential protection criterion is satisfied in case that the formula of the differential protection criterion is true, or the differential protection criterion is not satisfied in case that the formula of the differential protection criterion is false;
a formula of the second harmonic blocking criterion is formula (7):
$${I}_{diff 2 Φ} ( {t}_{aj} ) > {k}_{1} {I}_{diff Φ} ( {t}_{aj} ) , \qquad ( 7 )$$
wherein k₁ is a preset second coefficient, the second criterion results are that: the second harmonic blocking criterion is satisfied in case that the formula of the second harmonic blocking criterion is true, or the second harmonic blocking criterion is not satisfied in case that the formula of the second harmonic blocking criterion is false;
a formula of the waveform identification open criterion is formula (8):
$$\{ \begin{matrix}{I}_{diff ϕ} ( {t}_{2} ) > {I}_{cdqd} \\ \frac{{\sum }_{{t}_{0}}^{{t}_{1}} \vert {i}_{diff Φ} ( {t}_{aj} ) \vert}{{\sum }_{{t}_{1}}^{{t}_{2}} \vert {i}_{diff Φ} ( {t}_{aj} ) \vert} < {P}_{set}\end{matrix} , \qquad ( 8 )$$
wherein t₀ is a protection activation moment, t₁ is a first stage moment, t₂ is a second stage moment, t₁ and t₂ are empirical values determined based on an inrush current interruption angle feature, t₁<t₂<20 ms, Pₛₑₜ is an opening coefficient and is an empirical value set to ensure sensitivity to an inter-turn fault, the third criterion results are that: the waveform identification open criterion is satisfied in case that the three-phase differential currents i_{diffΦ}(tₐⱼ) make the formula of the waveform identification open criterion true, or the waveform identification open criterion is not satisfied in case that the three-phase differential currents i_{diffΦ}(tₐⱼ) make the formula of the waveform identification open criterion false;
formulas of the sequence differential current open criterion are formula (9) and formula (10):
$$\vert Δ {I}_{diffmax \pm } ( {t}_{aj} ) + 2 Δ {I}_{diffx \pm } ( {t}_{aj} ) \vert < \vert Δ {I}_{diffmax \pm } ( {t}_{aj} ) \vert , and \qquad ( 9 )$$
$$\vert Δ {I}_{diffmax \pm } ( {t}_{aj} ) + 2 Δ {I}_{diffy \pm } ( {t}_{aj} ) \vert < \vert Δ {I}_{diffmax \pm } ( {t}_{aj} ) \vert , \qquad ( 10 )$$
wherein ΔI_{diffmax±}(tₐⱼ)=max{ΔI_{diffA±}(tₐⱼ), ΔI_{diffB±}(tₐⱼ)ΔI_{diffC±}(tₐⱼ)}, ΔI_{diffx±}(tₐⱼ) and ΔI_{diffy±}(tₐⱼ) are the fundamental phasors of the positive and negative sequence component sums of the differential current variations of remaining two phases other than ΔI_{diffmax±}(tₐⱼ) among the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ), k₂<1; the fourth criterion results are that: a phase corresponding to ΔI_{diffmax±}(tₐⱼ) among the three phases satisfies the sequence differential current open criterion and remaining two phases do not satisfy the sequence differential current open criterion in case that the two formulas of the sequence differential current open criterion are both true; or none of the three phases satisfies the sequence differential current open criterion in case that either one of the two formulas of the sequence differential current open criterion is false.

5. The method according to claim 4, wherein the operation of determining the output results of the respective inter-turn protection actions according to the first criterion results, the second criterion results, the third criterion results, and the fourth criterion results of the three phases comprises:
in case that the first criterion result of a phase among the three phases is that the differential protection criterion is satisfied, and the second criterion result of the phase is that the second harmonic blocking criterion is not satisfied, determining an inter-turn protection action outlet of the phase; or in case that the first criterion result of a phase among the three phases is that the differential protection criterion is satisfied, the second criterion result of the phase is that the second harmonic blocking criterion is satisfied, the third criterion result of the phase is that the waveform identification open criterion is satisfied, and the fourth criterion result of the phase is that the sequence differential current open criterion is satisfied, determining an inter-turn protection action outlet of the phase.

6. An inter-turn protection system for a converter transformer, comprising:
a processor; and
a memory for storing instructions executable by the processor, wherein the processor is configured to:
acquire three-phase currents i_{Φpri}(tₐⱼ) of a grid side of a converter transformer at a moment tₐⱼ, three-phase currents i_{Φva}(tₐⱼ) of a valve side of the converter transformer at the moment tₐⱼ, and three-phase currents i_{Φpri}(t_{gj}) of the grid side of the converter transformer at a moment t_{gj} and three-phase currents i_{Φva}(t_{gj}) of the valve side at the moment t_{gj}, wherein Φ represents three phases A, B, and C of the converter transformer, t_{gj} is a j-th sampling moment of a time window before activation of inter-turn protection, tₐⱼ is a j-th sampling moment of an a-th time window after activation of inter-turn protection, N is a total number of sampling moments in one time window, a≥1, 1≤j≤N, a, j, and N are all natural numbers, and positive directions of the three-phase currents i_{Φpri}(tₐⱼ), i_{Φva}(tₐⱼ), i_{Φpri}(t_{gj}), and i_{Φva}(t_{gj}) are all directed to an inside of the converter transformer;
respectively calculate three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side; and respectively calculate three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj})) of the valve side;
respectively calculate fundamental effective values I_{diffΦ}(tₐⱼ) and second harmonic effective values I_{diff2Φ}(tₐⱼ) of the three-phase differential currents i_{diffΦ}(tₐⱼ) of the converter transformer at the moment tₐⱼ according to the three-phase differential currents i_{diffΦ}(tₐⱼ);
respectively calculate fundamental phasors ΔI_{diffΦ±}(tₐⱼ) of positive and negative sequence component sums Δi_{diffΦ±}(tₐⱼ) of three-phase differential current variations ΔI_{diffΦ}(tₐⱼ) of the converter transformer at the moment tₐⱼ according to the three-phase differential currents i_{diffΦ}(tₐⱼ) and the three-phase differential currents i_{diffΦ}(t_{gj});
respectively determine first criterion results of the three phases according to the fundamental effective values I_{diffΦ}(tₐⱼ) of the three-phase differential currents i_{diffΦ}(tₐⱼ) and a differential protection criterion which is preset; respectively determine second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and a second harmonic blocking criterion which is preset; respectively determine third criterion results of the three phases according to the three-phase differential currents i_{diffΦ}(tₐⱼ) and a waveform identification open criterion which is preset; and respectively determine fourth criterion results of the three phases according to the fundamental phasors ΔI_{diffΦ±}(tₐⱼ) and a sequence differential current open criterion which is preset; and
determine output results of respective inter-turn protection actions according to the first criterion results, the second criterion results, the third criterion results, and the fourth criterion results of the three phases.

7. The system according to claim 6, wherein the processor respectively calculates the three-phase differential currents i_{diffΦ}(tₐⱼ) of the converter transformer at the moment tₐⱼ according to the three-phase currents i_{Φpri}(tₐⱼ) of the grid side and the three-phase currents i_{Φva}(tₐⱼ) of the valve side, and respectively calculates the three-phase differential currents i_{diffΦ}(t_{gj}) of the converter transformer at the moment t_{gj} according to the three-phase currents i_{Φpri}(t_{gj}) of the grid side and the three-phase currents i_{Φva}(t_{gj}) of the valve side, wherein calculation formulas of the three-phase differential currents i_{diffΦ}(tₐⱼ) and i_{diffΦ}(t_{gj}) are respectively formula (1) and formula (2):
$${i}_{diff Φ} ( {t}_{aj} ) = {i}_{Φ pri} ( {t}_{aj} ) + {i}_{Φ va} ( {t}_{aj} ) \div ratio , and \qquad ( 1 )$$
$${i}_{diff Φ} ( {t}_{gi} ) = {i}_{Φ pri} ( {t}_{gi} ) + {i}_{Φ va} ( {t}_{gi} ) \div ratio , \qquad ( 2 )$$
wherein Φ represents the three phases A, B, and C, and the ratio is a converter transformer ratio.

8. The system according to claim 6, wherein the processor is further configured to:
respectively calculate the three-phase differential current variations Δi_{diffΦ}(tₐⱼ) of the converter transformer at the moment tₐⱼ according to the three-phase differential currents i_{diffΦ}(tₐⱼ) and i_{diffΦ}(t_{gj}), and a calculation formula of the three-phase differential current variations ΔI_{diffΦ}(tₐⱼ) is formula (3):
$$Δ {i}_{diff Φ} ( {t}_{aj} ) = {i}_{diff Φ} ( {t}_{aj} ) - {i}_{diff Φ} ( {t}_{gi} ) ; \qquad ( 3 )$$
calculate a zero-sequence component Δi_{diff0}(tₐⱼ) of the three-phase differential current variations Δi_{diffΦ}(tₐⱼ) of the converter transformer at the moment tₐⱼ according to the three-phase differential current variations Δi_{diffΦ}(tₐⱼ), and a calculation formula of the zero-sequence component Δi_{diff0}(tₐⱼ) is formula (4):
$$Δ {i}_{diff 0} ( {t}_{aj} ) = [ Δ {i}_{diffA} ( {t}_{aj} ) + Δ {i}_{diffB} ( {t}_{aj} ) + Δ {i}_{diffC} ( {t}_{aj} ) ] \div 3 ; \qquad ( 4 )$$
respectively calculate the positive and negative sequence component sums Δi_{diffΦ±}(tₐⱼ) of the three-phase differential current variations Δi_{diffΦ}(tₐⱼ) of the converter transformer at the moment tₐⱼ according to the three-phase differential current variations Δi_{diffΦ}(tₐⱼ) and the zero-sequence component Δi_{diff0}(tₐⱼ), and a calculation formula of the positive and negative sequence component sums Δi_{diffΦ±}(tₐⱼ) is formula (5):
$$Δ {i}_{diff Φ \pm } ( {t}_{aj} ) = Δ {i}_{diff Φ} ( {t}_{aj} ) - Δ {i}_{diff 0} ( {t}_{aj} ) ; \qquad ( 5 )$$
respectively calculate the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ) of the converter transformer at the moment tₐⱼ according to the positive and negative sequence component sums Δi_{diffΦ±}(tₐⱼ) of the three-phase differential current variations Δi_{diffΦ±}(tₐⱼ).

9. The system according to claim 8, wherein the processor is further configured to:
respectively determine the first criterion results of the three phases according to the fundamental effective values I_{diffΦ}(tₐⱼ) of the three-phase differential currents i_{diffΦ}(tₐⱼ) and the differential protection criterion which is preset, wherein a formula of the differential protection criterion is formula (6):
$$\{ \begin{matrix}{I}_{diff ϕ} ( {t}_{aj} ) > {I}_{cdqd} & {I}_{res ϕ} ( {t}_{aj} ) \leq {I}_{res 0} \\ {I}_{diff ϕ} ( {t}_{aj} ) > {I}_{cdqd} + {k}_{0} ( {I}_{res ϕ} ( {t}_{aj} ) - {I}_{res 0} ) & {I}_{res ϕ} ( {t}_{aj} ) > {I}_{res 0}\end{matrix} , \qquad ( 6 )$$
wherein I_{resΦ}(tₐⱼ)=|i_{Φpri}(tₐⱼ)−i_{Φva}(tₐⱼ)÷ratio|/2, Iᵣₑₛ₀ and k₀ are both constants, I_{cdqd} is a preset first coefficient, the first criterion results are that: the differential protection criterion is satisfied in case that the formula of the differential protection criterion is true, or the differential protection criterion is not satisfied in case that the formula of the differential protection criterion is false;
respectively determine the second criterion results of the three phases according to the fundamental effective values I_{diffΦ}(tₐⱼ) and the second harmonic effective values I_{diff2Φ}(tₐⱼ) of the three-phase differential currents i_{diffΦ}(tₐⱼ) and the second harmonic blocking criterion which is preset, wherein a formula of the second harmonic blocking criterion is formula (7):
$${I}_{diff 2 Φ} ( {t}_{aj} ) > {k}_{1} {I}_{diff Φ} ( {t}_{aj} ) , \qquad ( 7 )$$
wherein k₁ is a preset second coefficient, the second criterion results are that: the second harmonic blocking criterion is satisfied in case that the formula of the second harmonic blocking criterion is true, or the second harmonic blocking criterion is not satisfied in case that the formula of the second harmonic blocking criterion is false;
respectively determine the third criterion results of the three phases according to the three-phase differential currents i_{diffΦ}(tₐⱼ) and the waveform identification open criterion which is preset, wherein a formula of the waveform identification open criterion is formula (8):
$$\{ \begin{matrix}{I}_{diff ϕ} ( {t}_{2} ) > {I}_{cdqd} \\ \frac{{\sum }_{{t}_{0}}^{{t}_{1}} \vert {i}_{diff Φ} ( {t}_{aj} ) \vert}{{\sum }_{{t}_{1}}^{{t}_{2}} \vert {i}_{diff Φ} ( {t}_{aj} ) \vert} < {P}_{set}\end{matrix} , \qquad ( 8 )$$
wherein t₀ is a protection activation moment, t₁ is a first stage moment, t₂ is a second stage moment, t₁ and t₂ are empirical values determined based on an inrush current interruption angle feature, t₁<t₂<20 ms, Pₛₑₜ is an opening coefficient and is an empirical value set to ensure sensitivity to an inter-turn fault, the third criterion results are that: the waveform identification open criterion is satisfied in case that the three-phase differential currents i_{diffΦ}(tₐⱼ) make the formula of the waveform identification open criterion true, or the waveform identification open criterion is not satisfied in case that the three-phase differential currents i_{diffΦ}(tₐⱼ) make the formula of the waveform identification open criterion false; and
respectively determine the fourth criterion results of the three phases according to the fundamental phasors ΔI_{diffΦ±}(tₐⱼ) and the sequence differential current open criterion which is preset, wherein formulas of the sequence differential current open criterion are formula (9) and formula (10):
$$\vert Δ {I}_{diffmax \pm } ( {t}_{aj} ) + 2 Δ {I}_{diffx \pm } ( {t}_{aj} ) \vert < \vert Δ {I}_{diffmax \pm } ( {t}_{aj} ) \vert , and \qquad ( 9 )$$
$$\vert Δ {I}_{diffmax \pm } ( {t}_{aj} ) + 2 Δ {I}_{diffy \pm } ( {t}_{aj} ) \vert < \vert Δ {I}_{diffmax \pm } ( {t}_{aj} ) \vert , \qquad ( 10 )$$
wherein ΔI_{diffmax±}(tₐⱼ)=max{ΔI_{diffA±}(tₐⱼ), ΔI_{diffB±}(tₐⱼ), ΔI_{diffC±}(tₐⱼ)}, ΔI_{diffx±}(tₐⱼ) and ΔI_{diffy±}(tₐⱼ) are the fundamental phasors of the positive and negative sequence component sums of the differential current variations of remaining two phases other than ΔI_{diffmax±}(tₐⱼ) among the fundamental phasors ΔI_{diffΦ±}(tₐⱼ) of the positive and negative sequence component sums Δi_{diffΦ±}(tₐⱼ) of the three-phase differential current variations Δi_{diffΦ}(tₐⱼ), k₂<1; the fourth criterion results are that: a phase corresponding to ΔI_{diffmax±}(tₐⱼ) among the three phases satisfies the sequence differential current open criterion and remaining two phases do not satisfy the sequence differential current open criterion in case that the two formulas of the sequence differential current open criterion are both true; or none of the three phases satisfies the sequence differential current open criterion in case that either one of the two formulas of the sequence differential current open criterion is false.

10. The system according to claim 9, wherein the processor is further configured to: in case that the first criterion result of a phase among the three phases is that the differential protection criterion is satisfied and the second criterion result of the phase is that the second harmonic blocking criterion is not satisfied, determine an inter-turn protection action outlet of the phase; or in case that the first criterion result of a phase among the three phases is that the differential protection criterion is satisfied, the second criterion result of the phase is that the second harmonic blocking criterion is satisfied, the third criterion result of the phase is that the waveform identification open criterion is satisfied, and the fourth criterion result of the phase is that the sequence differential current open criterion is satisfied, determine an inter-turn protection action outlet of the phase.
